(19) United States
(12) Patent Application Publication
(10) Pub. No.: US 2024/0273587 A1
(43) Pub. Date: Aug. 15, 2024

(54) BILL PROCESSING

(71) Applicant: Alipay (Hangzhou) Information Technology Co., Ltd., Hangzhou (CN)

(72) Inventors: Yang ZHANG, Hangzhou (CN); Lijian CHEN, Hangzhou (CN); Min HUANG, Hangzhou (CN); Junwei WANG, Hangzhou (CN); Yue WANG, Hangzhou (CN)

(21) Appl. No.: 18/563,533

(22) PCT Filed: Jul. 4, 2022
(86) PCT No.: PCT/CN2022/103543

§ 371 Date: Nov. 22, 2023

(30) Foreign Application Priority Data
May 25, 2021 (CN) 202110573905.8

(51) Int. Cl. G06Q 30/04; G06Q 20/10

(52) U.S. Cl. CPC G06Q 30/04; G06Q 20/102

(57) ABSTRACT

Embodiments of this specification provide a bill processing method and apparatus. The bill processing method includes: determining a request category of a bill access request submitted by a user, collecting a business payment bill of the user based on the request category, to obtain a bill list; querying, in a ticket set of the user, a ticket associated with each business payment bill in the bill list; and configuring a ticket status of each business payment bill in the bill list based on a query result.

### TECHNICAL FIELD

This specification relates to the field of data processing technologies, and in particular, to a bill processing method and apparatus.

### BACKGROUND

In daily social life, processing of a ticket is usually involved. For example, processing such as application, issuance, submission, and review of the ticket may be involved. The ticket usually has specific voucher effect. For example, the ticket is used as an original basis for accounting in enterprises, and is also an important basis for law enforcement inspection by audit and tax institutions.

In a process of performing expense reimbursement by a user, the user usually needs to provide a ticket that matches an amount value and a bill type of a bill as a reimbursement voucher. Due to a reason such as insufficient paper tickets of a merchant, a ticket issued by the merchant may not be immediately obtained after the user makes a payment. Consequently, the user needs to spend more time and energy collecting the ticket that needs to be reimbursed.

### SUMMARY

One or more embodiments of this specification provide a bill processing method. The bill processing method includes: determining a request category of a bill access request submitted by a user; collecting a business payment bill of the user based on the request category, to obtain a bill list; querying, in a ticket set of the user, a ticket associated with each business payment bill in the bill list; and configuring a ticket status of each business payment bill in the bill list based on a query result.

One or more embodiments of this specification provide a bill processing apparatus. The bill processing apparatus includes: a category determining module, configured to determine a request category of a bill access request submitted by a user; a list obtaining module, configured to collect a business payment bill of the user based on the request category, to obtain a bill list; a ticket query module, configured to query, in a ticket set of the user, a ticket associated with each business payment bill in the bill list; and a status configuration module, configured to configure a ticket status of each business payment bill in the bill list based on a query result.

One or more embodiments of this specification provide an electronic device, including a processor and a storage configured to store computer-executable instructions. When the computer-executable instructions are executed, the processor is enabled to perform the following operations: determining a request category of a bill access request submitted by a user; collecting a business payment bill of the user based on the request category, to obtain a bill list; querying, in a ticket set of the user, a ticket associated with each business payment bill in the bill list; and configuring a ticket status of each business payment bill in the bill list based on a query result.

One or more embodiments of this specification provide a storage medium, configured to store computer-executable instructions. When the computer-executable instructions are executed, the following procedure is implemented: determining a request category of a bill access request submitted by a user; collecting a business payment bill of the user based on the request category, to obtain a bill list; querying, in a ticket set of the user, a ticket associated with each business payment bill in the bill list; and configuring a ticket status of each business payment bill in the bill list based on a query result.

### BRIEF DESCRIPTION OF DRAWINGS

To describe the technical solutions in one or more embodiments of this specification or in the conventional technology more clearly, the following briefly describes the accompanying drawings needed for describing the embodiments or the conventional technology. Clearly, the accompanying drawings in the following description merely show some embodiments of this specification, and a person of ordinary skill in the art can still derive other drawings from these accompanying drawings without creative efforts.

FIG. 1 is a processing flowchart of a bill processing method according to one or more embodiments of this specification;

FIG. 2 is a schematic diagram of a bill reimbursement scenario of a bill processing method according to one or more embodiments of this specification;

FIG. 3 is a processing flowchart of a bill processing method applied to a bill reimbursement scenario according to one or more embodiments of this specification;

FIG. 4 is a schematic diagram of a structure of a bill processing apparatus according to one or more embodiments of this specification; and

FIG. 5 is a schematic diagram of a structure of an electronic device according to one or more embodiments of this specification.

### DESCRIPTION OF EMBODIMENTS

To make a person skilled in the art understand the technical solutions in one or more embodiments of this specification better, the following clearly and comprehensively describes the technical solutions in the one or more embodiments of this specification with reference to the accompanying drawings in the one or more embodiments of this specification. Clearly, the described embodiments are merely some but not all of the embodiments of this specification. All other embodiments obtained by a person of ordinary skill in the art based on the one or more embodiments of this specification without creative efforts shall fall within the protection scope of this specification.

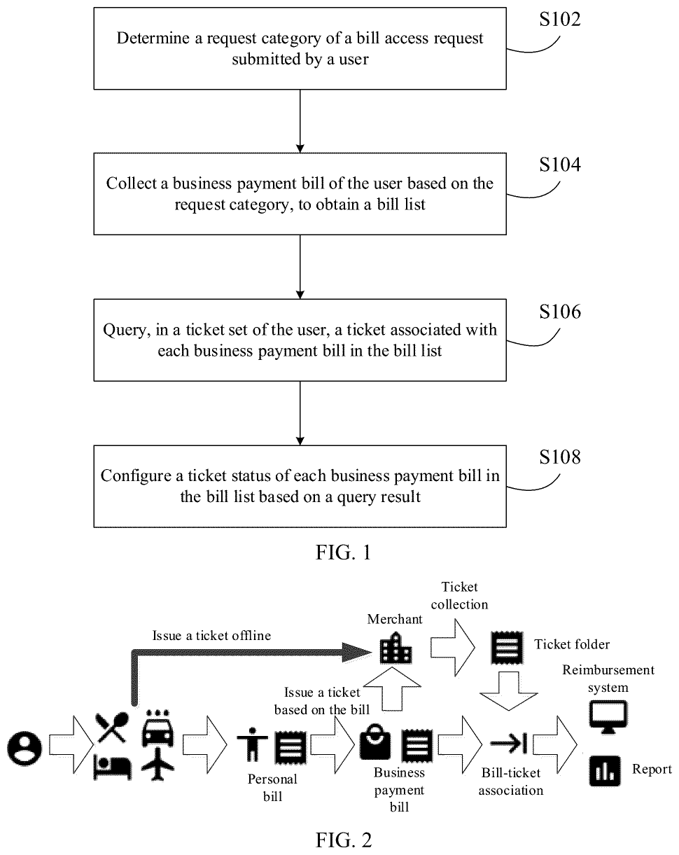

This specification provides an embodiment of a bill processing method. FIG. 1 is a processing flowchart of a bill processing method according to one or more embodiments of this specification.

The bill processing method provided in this embodiment can be performed by a server.

As shown in FIG. 1, the bill processing method provided in this embodiment specifically includes the following steps S102 to S108.

According to the bill processing method provided in this embodiment, a business payment bill is collected and a ticket status of the business payment bill is configured, to help, from a bill perspective, a user intuitively perceive an obtained ticket and a ticket that is not obtained, so as to avoid a reimbursement loss caused due to omission of some tickets.

Step S102: Determine a request category of a bill access request submitted by a user.

In this embodiment, the user can be an enterprise employee, or can be an institution member. The bill access request can be an access request for a business payment bill generated after the user makes a business payment. The request category includes and is not limited to a first request category corresponding to a bill label or a bill group, a second request category corresponding to an application form, and a third request category corresponding to a custom condition. The above-mentioned request categories are merely several examples, and the request category can further include a request category in which a plurality of bill obtaining rules are combined, and the like. Details are omitted for simplicity here.

For a bill access request of the first request category, a business payment bill can be selected from a personal account by using a specified bill label or a specified bill group. For a bill access request of the second request category, a business payment bill can be selected from a personal account and/or an enterprise account by using a pre-filled target application form. For a bill access request of the third request category, a business payment bill can be selected from a personal account and/or an enterprise account by using a specified selection condition.

A business payment can occur in a business trip scenario, for example, a scenario in which a train ticket between a business trip location and a home location is purchased; can occur in a scenario in which items needed for work are purchased, for example, a scenario in which office supplies are purchased; or can occur in a scenario in which a customer is entertained, for example, a scenario in which the customer is invited to have a dinner. The above-mentioned several scenarios are merely several examples, and there are other business payment scenarios. Details are omitted for simplicity here.

Optionally, the bill processing method is applied to a payment application, and the determining a request category of a bill access request submitted by a user includes: obtaining a bill access request submitted by the user in the payment application, where the bill access request carries a request category identifier of a request category selected by the user; and determining the request category of the bill access request from a plurality of preset request categories based on the request category identifier.

The plurality of preset request categories include and are not limited to the first request category corresponding to the bill label or the bill group, the second request category corresponding to the application form, and the third request category corresponding to the custom condition. Alternatively, the plurality of preset request categories can include only any two of the first request category, the second request category, and the third request category.

There is a one-to-one correspondence between the request category identifier and the preset request category. The request category of the bill access request can be determined by using the correspondence between the request category identifier and the preset request category.

From a perspective of a user terminal, the user terminal can perform the following steps: The user terminal obtains a request category selection action and a bill access action submitted by the user in the first request category, the second request category, and the third request category; and the user terminal sends a bill access request to the server based on the bill access action, where the bill access request carries a request category identifier of a target request category selected by using the request category selection action.

Step S104: Collect a business payment bill of the user based on the request category, to obtain a bill list.

Optionally, the collecting a business payment bill of the user based on the request category, to obtain a bill list includes: selecting and collecting a business payment bill corresponding to a specified bill label or a specified bill group from a personal account of the user if the request category is the first request category corresponding to the bill label or the bill group, to obtain the bill list.

In an embodiment, before the business payment bill corresponding to the specified bill label or the specified bill group is selected and collected from the personal account of the user, the following operation can be further performed: associating the specified bill label with a to-be-processed bill based on a label addition request of the user for the to-be-processed bill. For example, the user manually adds a business travel label to a bill for purchasing a train ticket during a business trip.

In another embodiment, before the business payment bill corresponding to the specified bill label or the specified bill group is selected and collected from the personal account of the user, the following operation can be further performed: associating a to-be-processed bill with the specified bill group based on a group request of the user for the to-be-processed bill.

The associating a to-be-processed bill with the specified bill group based on a group request of the user for the to-be-processed bill can be understood as follows: The to-be-processed bill is not originally associated with any bill group, and after the server obtains the group request of the user for the to-be-processed bill, the server associates the to-be-processed bill with the specified bill group.

In still another embodiment, before the business payment bill corresponding to the specified bill label or the specified bill group is selected and collected from the personal account of the user, the following operation can be further performed: updating a bill group associated with a to-be-processed bill to the specified bill group based on a group update request of the user for the to-be-processed bill.

In specific implementation, the selecting and collecting a business payment bill corresponding to a specified bill label or a specified bill group from a personal account of the user if the request category is the first request category corresponding to the bill label or the bill group, to obtain the bill list includes: if the request category is the first request category corresponding to the bill label or the bill group, reading the specified bill label or the specified bill group; and performing selection from the personal account of the user by using the specified bill label or the specified bill group as a selection condition, to obtain the business payment bill.

It should be understood that for the personal account, the business payment bill needs to be selected and collected based on the bill label or the bill group. This is because the personal account may be used to make both a business payment and a private payment, that is, bills in the personal account may include both a personal payment bill and the business payment bill. Usually, all bills obtained after a payment is made by using an enterprise account are business payment bills. Therefore, the first request category is applicable to the personal account.

In another embodiment, if the request category is a fourth request category corresponding to a bill label or a bill group, a first business payment bill corresponding to a specified bill label or a specified bill group is selected and collected from a personal account of the user, and a second business payment bill is obtained from an enterprise account used by the user.

Optionally, the collecting a business payment bill of the user based on the request category, to obtain a bill list includes: if the request category is the second request category corresponding to the application form, determining at least one target bill type and a bill quantity of each target bill type based on a pre-filled target application form; for any target bill type, performing, based on the target bill type, selection from a personal account of the user and/or an enterprise account used by the user, to obtain a to-be-processed bill; ranking the to-be-processed bill according to a preset rule, and selecting a corresponding to-be-processed bill as the business payment bill based on the bill quantity; and collecting the business payment bill to obtain the bill list.

The performing, based on the target bill type, selection from a personal account of the user and/or an enterprise account used by the user can be determining a target bill label or a target bill group corresponding to the target bill type, and performing selection from the personal account and/or the enterprise account based on a specified time period, the target bill label, or the target bill group, to obtain the to-be-processed bill.

The target application form can be a purchase application form, a business travel application form, or an entertainment application form. The target application form can be understood as a template that includes a plurality of to-be-filled areas and that is preconfigured according to an application rule. For example, the purchase application form includes purchase of _ pieces of stationery and _ household appliances; and the business travel application form includes _ days of accommodation in a hotel, _ train tickets, and _ air tickets. Here, the character (string) “_” represents a to-be-filled area.

For example, the target application form pre-filled by the user is a purchase application form, and content of the purchase application form includes purchase of “five” pieces of stationery and “one” household appliance. In this case, two target bill types, namely, stationery and household appliance, are determined based on the purchase application form. It is determined that a target bill label corresponding to the stationery is “stationery and sporting goods”, and selection from the personal account and/or the enterprise account is performed based on the target bill label “stationery and sporting goods”, to obtain 10 to-be-processed bills.

The to-be-processed bill is ranked according to the preset rule. The preset rule can be that ranking is performed in descending order of generation times of bills, or can be that ranking is performed in ascending order or descending order of generation times of bills in a specified time period.

The to-be-processed bill is ranked according to the preset rule, and the corresponding to-be-processed bill is selected as the business payment bill based on the bill quantity. For example, for the 10 to-be-processed bills obtained through screening in the above-mentioned step, ranking is performed in descending order of generation times of the to-be-processed bills. A bill quantity corresponding to the stationery is 5. Therefore, based on a ranking result, five to-be-processed bills are selected from back to front as business payment bills. A method for obtaining one business payment bill corresponding to the household appliance is similar to the method for obtaining the five business payment bills corresponding to the stationery. Details are omitted for simplicity here.

The collecting the business payment bill to obtain the bill list can be understood as collecting business payment bills corresponding to all target bill types in one bill list.

Optionally, the determining at least one target bill type and a bill quantity of each target bill type based on a pre-filled target application form includes: determining, based on the pre-filled target application form, at least one application quantity filled in the target application form and an area identifier of a to-be-filled area in which each application quantity is located; determining a corresponding target bill type based on each area identifier; and using an application quantity filled in each to-be-filled area as a bill quantity of a target bill type corresponding to an area identifier of the to-be-filled area.

The determining, based on the pre-filled target application form, at least one application quantity filled in the target application form and an area identifier of a to-be-filled area in which each application quantity is located can be understood as follows: The target application form includes a text part and a plurality of to-be-filled areas, and an area identifier of each to-be-filled area corresponds to one bill type.

For example, the purchase application form includes purchase of three pieces of stationery and one household appliance. Here, “purchase of”, “pieces of stationery and”, and “household appliance” are text parts in the purchase application form, and an area identified by an underline between “purchase of” and “pieces of stationery and” is a to-be-filled area. It is assumed that an area identifier of the to-be-filled area is “A1”, and there is a correspondence between “A1” and a bill type “stationery”. In this case, a value “3” filled in the to-be-filled area corresponding to “A1” is a bill quantity of the target bill type “stationery”. Similarly, a value “1” filled in a to-be-filled area between “stationery and” and “household appliance” is a bill quantity of a target bill type “household appliance”.

It is worthwhile to note that although all bills obtained after a payment is made by using the enterprise account are business payment bills, the bill list obtained by using the bill access request of the second request category corresponding to the application form is a bill list that includes a business payment bill that meets the target application form. Therefore, selection from the enterprise account used by the user needs to be performed based on the target bill type, instead of adding all bills in the enterprise account to the bill list.

In another embodiment, the determining at least one target bill type and a bill quantity of each target bill type based on a pre-filled target application form can alternatively be determining, based on the pre-filled target application form, at least one application quantity filled in the target application form and a target bill type that is selected by the user and that corresponds to the application quantity. A plurality of to-be-selected bill types can be preset in the target application form.

The bill list is obtained by using the bill access request of the second request category, so that a business payment bill that meets the pre-filled application form can be obtained in a targeted manner, to help the user intuitively view each business payment bill generated in a complete business expenditure activity. The business expenditure activity includes and is not limited to a business travel activity, a purchase activity, or an entertainment activity.

Optionally, the collecting a business payment bill of the user based on the request category, to obtain a bill list includes: if the request category is the third request category corresponding to the custom condition, selecting and collecting a business payment bill from a personal account of the user based on a specified selection condition, to obtain the bill list, where the selection condition includes at least one of the following: a time period to which a bill belongs, a bill label, a bill group, or a bill reimbursement status.

The time period to which a bill belongs is a time period to which a generation time of the bill belongs. A bill reimbursement status of a business payment bill includes reimbursed and unreimbursed. A non-business payment bill does not have a bill reimbursement requirement, and therefore does not have a bill reimbursement status. The bill reimbursement status can be generated in a process of performing step S104. For example, in a process of collecting the business payment bill of the user based on the request category, when the business payment bill is obtained, a bill reimbursement status corresponding to the business payment bill is generated, and the bill reimbursement status is set to an initial value “unreimbursed”. After the business payment bill is submitted to a reimbursement system, the bill reimbursement status of the business payment bill is updated from “unreimbursed” to “reimbursed”.

For example, based on a specified time period “X-month Y-day-X-month Z-day” to which a bill belongs and a specified bill group “business travel”, a business payment bill is selected and collected from the personal account of the user, to obtain the bill list.

Step S106: Query, in a ticket set of the user, a ticket associated with each business payment bill in the bill list.

Optionally, the bill processing method further includes: obtaining a ticket uploaded by the user and a user identifier of the user; adding the ticket to the ticket set of the user based on the ticket and the user identifier; and associating the ticket with at least one bill based on a bill-ticket association operation performed by the user on the at least one selected bill and the ticket.

The ticket uploaded by the user and the user identifier of the user may be obtained before step S102, or may be obtained after step S102. That is, before the server obtains the bill access request, or after the server obtains the bill access request, the server may obtain the ticket that is uploaded by the user and that is associated with the business payment bill.

The ticket set of the user is determined based on the user identifier, and the ticket is added to the ticket set.

When a ticket and a bill are associated, it needs to be considered that there may be a one-to-one or many-to-one association relationship between the bill and the ticket. For example, if the user makes a plurality of business payments in a restaurant and obtains a plurality of corresponding business payment bills, for convenience, the user requests only one ticket from the restaurant. The ticket is issued by the restaurant based on the plurality of business payment bills. Specifically, if the employee spends A yuan in the first business payment, spends B yuan in the second business payment, and spends C yuan in the third business payment, a value of a ticket issued by the restaurant based on three business payment bills is (A+B+C) yuan.

The ticket uploaded by the user can be a paper ticket, or can be an electronic ticket received by mail. A manner of uploading a paper ticket can be to capture an image of the paper ticket by using a camera or a scanner.

Optionally, the bill processing method further includes: obtaining a ticket sent by a merchant, at least one bill identifier bound to the ticket, and a user identifier of the user; adding the ticket to the ticket set of the user based on the user identifier; and associating the ticket with at least one bill corresponding to the bill identifier.

The obtaining a ticket sent by a merchant can be understood as follows: After the user sends ticket request information to the merchant for the business payment bill, the merchant issues an associated ticket based on a bill identifier of the business payment bill and sends the associated ticket to the user.

If the user sends combined ticket request information to the same merchant for a plurality of business payment bills, the merchant issues an associated ticket based on bill identifiers of the plurality of business payment bills and sends the associated ticket to the user. The ticket is added to the ticket set of the user based on the user identifier; and the ticket is associated with the at least one bill corresponding to the bill identifier.

Optionally, the bill processing method further includes: for any ticket, determining, based on a bill identifier of any associated bill associated with the ticket, whether the associated bill belongs to the bill list; and updating a ticket status of the associated bill if the associated bill belongs to the bill list.

A ticket status of a business payment bill includes “returned” and “not returned”. At any time point, a ticket status of one business payment bill can only be one of “returned” and “not returned”.

After the ticket uploaded by the user is obtained and the ticket is associated with the at least one bill, it is determined whether the associated bill associated with the ticket belongs to the bill list, and if the associated bill belongs to the bill list, a ticket status of the associated bill is updated from “not returned” to “returned”.

After the ticket sent by the merchant is obtained and the ticket is associated with the at least one bill corresponding to the bill identifier, it is determined whether the associated bill associated with the ticket belongs to the bill list, and if the associated bill belongs to the bill list, a ticket status of the associated bill is updated from a state in which there is no associated ticket to a state in which there is an associated ticket.

Step S108: Configure a ticket status of each business payment bill in the bill list based on a query result.

Optionally, the configuring a ticket status of each business payment bill in the bill list based on a query result includes: determining, based on the query result of the ticket associated with each business payment bill, a ticket status corresponding to the query result; determining the ticket status of each business payment bill as a configuration parameter of a display page of the business payment bill; and rendering and generating the display page of the business payment bill based on the configuration parameter.

The query result of the ticket includes that there is an associated ticket and that there is no associated ticket. That there is an associated ticket here means that it is determined, based on an association relationship between a ticket stored in the server and at least one business payment bill, that there is a ticket associated with a business payment bill. The ticket can be uploaded by the user to the server, or can be sent by the merchant to an account of the user. That there is no associated ticket here means that it is determined, based on an association relationship between a ticket stored in the server and at least one business payment bill, that there is no ticket associated with a business payment bill.

If a query result of a ticket of a business payment bill is that there is an associated ticket, a ticket status of the business payment bill is “returned”. If a query result of a ticket of a business payment bill is that there is no associated ticket, a ticket status of the business payment bill is “not returned”.

The ticket status of each business payment bill is determined as the configuration parameter of the display page of the business payment bill, and the display page of the business payment bill is rendered and generated based on the configuration parameter, so that business payment bills with different ticket statuses are differentially displayed on the display page. For example, if a ticket status of a bill 1 is “returned”, text “returned” is displayed on a right side of the bill 1; and if a ticket status of a bill 5 is “not returned”, text “not returned” is displayed on a right side of the bill 5.

Business payment bills with different ticket statuses are differentially displayed, to help the user more intuitively perceive a bill corresponding to a ticket status “not returned”, so as to prompt the user to upload a ticket or request a ticket from the merchant in a timely manner.

According to the bill processing method provided in this embodiment, a target business payment bill selected by the user and an associated target ticket can be further determined based on a reimbursement report generation request of the user, and then a report is generated based on the target business payment bill and the associated target ticket for uploading to the reimbursement system.

In conclusion, according to the bill processing method provided in this embodiment, first, the request category of the bill access request submitted by the user is determined; then, the business payment bill of the user is collected based on the request category, to obtain the bill list; then, the ticket associated with each business payment bill in the bill list is queried in the ticket set of the user; and finally, the ticket status of each business payment bill is configured in the bill list based on the query result. In this technical solution, the business payment bill can be flexibly collected based on a user requirement, and the ticket status of each business payment bill is configured, so that the user can intuitively perceive, from the bill perspective, whether the ticket associated with each business payment bill is omitted.

The bill processing method provided in the embodiments of this specification is further described below with reference to a bill reimbursement scenario.

FIG. 2 is a schematic diagram of a bill reimbursement scenario of a bill processing method according to one or more embodiments of this specification.

As shown in FIG. 2, in the bill reimbursement scenario, a user can obtain a ticket in two manners after performing a business payment operation: One manner is that the user issues a ticket offline through a merchant. The other manner is that after performing the business payment operation by using a personal account, the user first obtains a personal bill, and then obtains a bill list of a business payment bill based on the personal bill, and the user issues a ticket through a merchant based on the bill list. Tickets obtained in the two manners are collected in a ticket folder. When a ticket is collected in a ticket folder, a server establishes an association relationship between the ticket and at least one business payment bill. A ticket status of each business payment bill is determined based on the association relationship between the ticket and the at least one business payment bill. The user can determine, based on the ticket status of each business payment bill, whether to perform reimbursement, or determine a business payment bill to be used as a to-be-reimbursed bill. The server can generate a report based on the to-be-reimbursed bill and an associated ticket, and upload the report to a reimbursement system.

In the method embodiment shown in FIG. 2, the processes in the above-mentioned method embodiment can be implemented. Details are omitted for simplicity here.

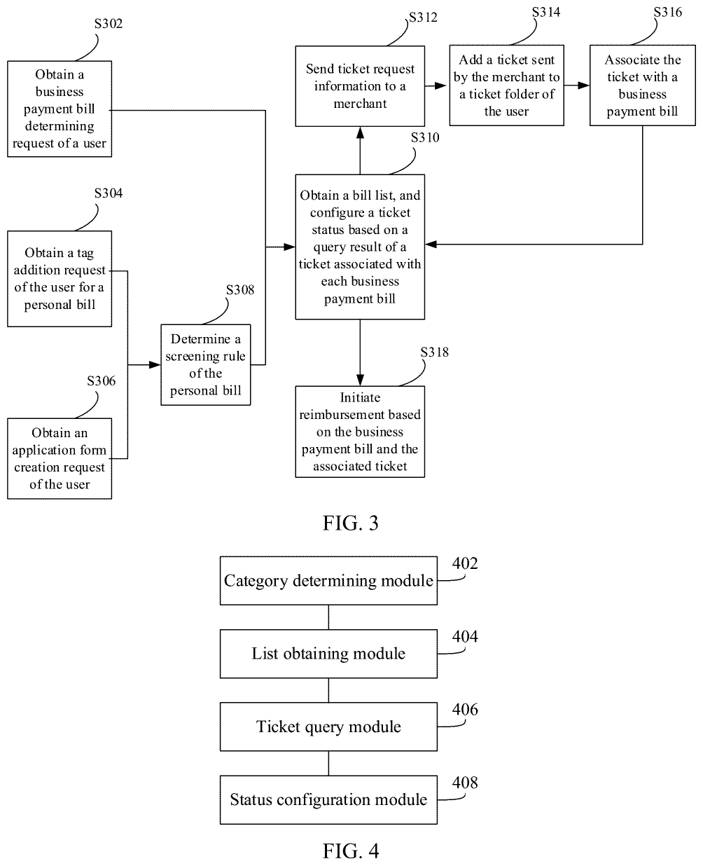

FIG. 3 is a processing flowchart of a bill processing method applied to a bill reimbursement scenario according to one or more embodiments of this specification.

As shown in FIG. 3, the bill processing method provided in this embodiment includes steps S302 to S318.

This embodiment can be performed by a server.

Step S302: Obtain a business payment bill determining request of a user.

In specific implementation, a user terminal obtains a business payment bill determining operation performed by the user, and the user terminal generates, based on the business payment bill determining operation, the business payment bill determining request to be sent to the server. The server receives the business payment bill determining request sent by the user terminal. The business payment bill determining operation can include a business payment bill selection operation and/or a business payment bill confirmation operation.

The following describes the business payment bill determining operation by using two specific examples.

For example, a display interface of a personal bill of the user is used to display a personal bill list. The personal bill list includes a bill 1, a bill 2, a bill 3, a bill 4, and a bill 5. After the user clicks a bill generation control of a business payment bill, a bill multi-selection mode is entered. In the bill multi-selection mode, a corresponding multi-selection box appears on a left side of each personal bill. The user clicks multi-selection boxes on left sides of the bill 1, the bill 3, and the bill 5, and then clicks an OK control.

For another example, a display interface of a personal bill of the user is used to display a personal bill list. The personal bill list includes a bill 1, a bill 2, a bill 3, a bill 4, and a bill 5. The user clicks an edit control of the bill 3, and an edit menu pops up on a right side of the edit control. The edit menu includes a plurality of edit options, for example, “add to business payment bill”. The user clicks the edit option of “add to business payment bill”. “Add to business payment bill” here actually means that the bill 3 is determined as a business payment bill, and the bill 3 is added to a bill list of the business payment bill.

The business payment bill determining request is generated by the user terminal based on the business payment bill determining operation, and carries a bill identifier of a personal bill selected by the user.

After step S302 is performed by the server, the server performs step S310.

Step S304: Obtain a tag addition request of the user for the personal bill.

In specific implementation, the user terminal obtains a tag addition operation performed by the user on the personal bill, and the user terminal generates, based on the tag addition operation, the tag addition request to be sent to the server. The server receives the tag addition request sent by the user terminal. The tag addition request carries the bill identifier of the personal bill selected by the user.

After step S304 is performed by the server, the server performs step S308.

Step S306: Obtain an application form creation request of the user.

In specific implementation, the user terminal obtains an application form creation operation performed by the user, and the user terminal generates, based on the application form creation operation, the application form creation request to be sent to the server. The server receives the application form creation request sent by the user terminal.

An application form created by the user can be a purchase application form, a business travel application form, or an entertainment application form. The application form can be understood as a template that includes a plurality of to-be-filled areas and that is preconfigured according to an application rule. For example, the purchase application form includes purchase of _ pieces of stationery and _ household appliances; and the business travel application form includes _ days of accommodation in a hotel, train tickets, and _ air tickets. Here, the character (string) “_” represents a to-be-filled area.

The application form creation operation can be an application form filling operation performed based on a preset application form template.

After step S306 is performed by the server, the server performs step S308.

Step S308: Determine a screening rule of the personal bill.

The screening rule of the personal bill is determined based on the tag addition request or the application form creation request.

For example, a display interface of a personal bill of the user is used to display a personal bill list. The personal bill list includes a bill 1, a bill 2, a bill 3, a bill 4, and a bill 5. If the user adds a “business travel” label to the bill 1 and the bill 4, the determining the screening rule of the personal bill based on the label addition request is screening each personal bill in the personal bill list based on the “business travel” label.

For another example, if the user creates a purchase application form based on a preset purchase application form template, the determining the screening rule of the personal bill based on the application form creation request is: determining at least one target bill type and a bill quantity of each target bill type based on the purchase application form created by the user; for any target bill type, performing, based on the target bill type, selection from a personal account of the user, to obtain a to-be-processed bill; and ranking the to-be-processed bill according to a preset rule, and selecting a corresponding to-be-processed bill based on the bill quantity.

Step S310: Obtain a bill list, and configure a ticket status based on a query result of a ticket associated with each business payment bill.

The bill list of the business payment bill is constructed based on one or more business payment bills determined in step S302 or one or more business payment bills obtained after the personal bill of the user is screened by using the screening rule in step S308. The ticket associated with each business payment bill in the bill list is queried in a ticket set corresponding to a ticket folder of the user, and the ticket status of each business payment bill is configured in the bill list based on the ticket query result.

The query result of the ticket includes that there is an associated ticket or that there is no associated ticket. That there is an associated ticket here means that it is determined, based on an association relationship between a ticket stored in the server and at least one business payment bill, that there is a ticket associated with a business payment bill. The ticket can be uploaded by the user to the server, or can be sent by a merchant to an account of the user. That there is no associated ticket here means that it is determined, based on an association relationship between a ticket stored in the server and at least one business payment bill, that there is no ticket associated with a business payment bill.

If a query result of a ticket of a business payment bill is that there is an associated ticket, a ticket status of the business payment bill is “returned”. If a query result of a ticket of a business payment bill is that there is no associated ticket, a ticket status of the business payment bill is “not returned”.

It is worthwhile to note that after step S316 is performed, when step S310 is performed again, the query result of querying, in the ticket set corresponding to the ticket folder of the user, the ticket associated with each business payment bill is changed. It can be understood that after a ticket sent by the merchant is associated with a business payment bill corresponding to a bill identifier, if a query result of querying, in the ticket set corresponding to the ticket folder of the user, a ticket associated with the business payment bill is changed from a state in which there is no associated ticket to a state in which there is an associated ticket, a ticket status of the business payment bill is configured based on a changed query result.

After step S316 is performed, when step S310 is performed again, the obtained bill list and the ticket status of each configured business payment bill can be directly read. On this basis, configuration update processing is performed on a ticket status of a business payment bill corresponding to a bill identifier in step S316.

Step S312: Send ticket request information to the merchant.

When a ticket status of a business payment bill in the bill list is “not returned”, the user can request an electronic ticket associated with the business payment bill from the merchant. The server can send the ticket request information to the merchant based on an obtained ticket request operation performed by the user.

In specific implementation, the server generates the ticket request information based on the obtained ticket request operation performed by the user, and sends the ticket request information to the merchant. The ticket request information includes a user identifier of the user and a bill identifier of at least one business payment bill.

Step S314: Add a ticket sent by the merchant to the ticket folder of the user.

The ticket sent by the merchant can be an electronic ticket. The merchant can issue the electronic ticket based on the ticket request information sent by the server in step S312. The server obtains the electronic ticket that is sent by the merchant based on the user identifier and that is associated with the bill identifier.

Step S316: Associate the ticket with the business payment bill.

The electronic ticket sent by the merchant is associated with the business payment bill corresponding to the bill identifier, that is, an association relationship is established between the business payment bill corresponding to the bill identifier and the electronic ticket.

After step S316 is performed by the server, the server performs step S310 again.

Step S318: Initiate reimbursement based on the business payment bill and the associated ticket.

After step S310 is performed, the server initiates reimbursement based on the business payment bill and the associated ticket in response to an obtained ticket reimbursement initiation request. The ticket reimbursement initiation request can carry a bill identifier of a to-be-reimbursed business payment bill.

In specific implementation, the server obtains the to-be-reimbursed bill and an associated ticket based on the bill identifier that is of the to-be-reimbursed business payment bill and that is carried in the ticket reimbursement initiation request; the server generates a report based on the to-be-reimbursed bill and the associated ticket; and the server sends the report to a reimbursement system.

In the method embodiment shown in FIG. 3, the processes in the above-mentioned method embodiment can be implemented. Details are omitted for simplicity here.

In conclusion, according to the bill processing method provided in this embodiment, first, the request category of the bill access request submitted by the user is determined; then, the business payment bill of the user is collected based on the request category, to obtain the bill list; then, the ticket associated with each business payment bill in the bill list is queried in the ticket set of the user; and finally, the ticket status of each business payment bill is configured in the bill list based on the query result. In this technical solution, the business payment bill can be flexibly collected based on a user requirement, and the ticket status of each business payment bill is configured, so that the user can intuitively perceive, from the bill perspective, whether the ticket associated with each business payment bill is omitted.

Corresponding to the bill processing method described in FIG. 1, based on the same technical concept, one or more embodiments of this specification further provide a bill processing apparatus. FIG. 4 is a schematic diagram of a structure of a first bill processing apparatus according to one or more embodiments of this specification. As shown in FIG. 4, the bill processing apparatus includes: a category determining module 402, configured to determine a request category of a bill access request submitted by a user; a list obtaining module 404, configured to collect a business payment bill of the user based on the request category, to obtain a bill list; a ticket query module 406, configured to query, in a ticket set of the user, a ticket associated with each business payment bill in the bill list; and a status configuration module 408, configured to configure a ticket status of each business payment bill in the bill list based on a query result.

It is worthwhile to note that the embodiment of the bill processing apparatus in this specification and the embodiment of the bill processing method in this specification are based on the same inventive concept. Therefore, for specific implementation of the embodiment, references can be made to the above-mentioned implementation of the corresponding bill processing method, and repeated parts are omitted for simplicity.

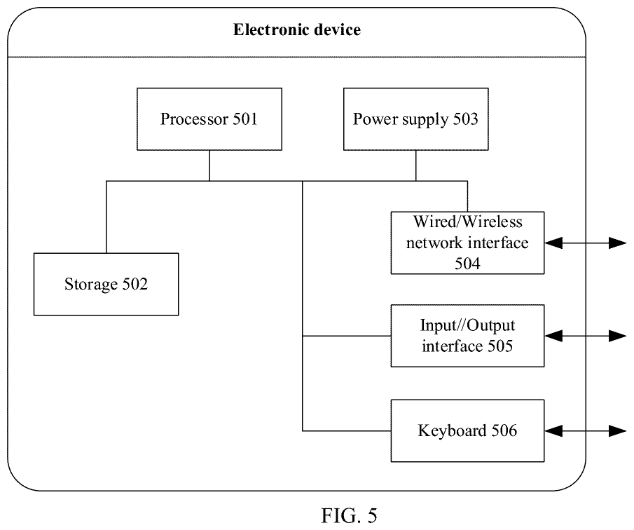

Corresponding to the bill processing method that is described above and that is applied to an electronic device, based on the same technical concept, one or more embodiments of this specification further provide an electronic device. The electronic device is configured to perform the bill processing method provided above. FIG. 5 is a schematic diagram of a structure of an electronic device according to one or more embodiments of this specification.

The electronic device provided in this embodiment includes the following: As shown in FIG. 5, the electronic device can vary greatly based on configuration or performance, and can include one or more processors 501 and a storage 502. The storage 502 can store one or more storage applications or data. The storage 502 can be a temporary storage or a persistent storage. The application stored in the storage 502 can include one or more modules (not shown in the figure), and each module can include a series of computer-executable instructions in the electronic device. Further, the processor 501 can be configured to communicate with the storage 502, and execute a series of computer-executable instructions in the storage 502 on the electronic device. The electronic device can further include one or more power supplies 503, one or more wired or wireless network interfaces 504, one or more input/output interfaces 505, one or more keyboards 506, and the like.

In a specific embodiment, the electronic device includes a storage and one or more programs. The one or more programs are stored in the storage. The one or more programs can include one or more modules. Each module can include a series of computer-executable instructions in the electronic device. The one or more programs are configured to be executed by the one or more processors to execute the following computer-executable instructions: determining a request category of a bill access request submitted by a user; collecting a business payment bill of the user based on the request category, to obtain a bill list; querying, in a ticket set of the user, a ticket associated with each business payment bill in the bill list; and configuring a ticket status of each business payment bill in the bill list based on a query result.

An embodiment of a storage medium provided in this specification is as follows: Corresponding to the bill processing method described above, based on the same technical concept, one or more embodiments of this specification further provide a storage medium. In a specific embodiment, the storage medium can be a USB flash drive, an optical disc, a hard disk, or the like.

The storage medium provided in this embodiment is configured to store computer-executable instructions. When the computer-executable instructions are executed, the following procedure is implemented: determining a request category of a bill access request submitted by a user; collecting a business payment bill of the user based on the request category, to obtain a bill list; querying, in a ticket set of the user, a ticket associated with each business payment bill in the bill list; and configuring a ticket status of each business payment bill in the bill list based on a query result.

It is worthwhile to note that the embodiment of the storage medium in this specification and the embodiment of the bill processing method in this specification are based on the same inventive concept. Therefore, for specific implementation of the embodiment, references can be made to the above-mentioned implementation of the corresponding method, and repeated parts are omitted for simplicity.

Specific embodiments of this specification are described above. Other embodiments fall within the scope of the appended claims. In some cases, the actions or steps described in the claims can be performed in an order different from that in the embodiments, and the desired results can still be achieved. In addition, the process depicted in the accompanying drawings does not necessarily need a particular order or consecutive order to achieve the desired results. In some implementations, multi-tasking and parallel processing are feasible or may be advantageous.

In the 1930s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). At present, the Very-High-Speed Integrated Circuit Hardware Description Language (VHDL) and Verilog are most commonly used. It should also be clear to a person skilled in the art that a hardware circuit for implementing a logical method procedure can be easily obtained by performing slight logic programming on the method procedure by using the above-mentioned several hardware description languages and programming the method procedure into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The storage controller can also be implemented as a part of the control logic of the storage. A person skilled in the art also knows that in addition to implementing the controller by using only the computer-readable program code, logic programming can be performed on method steps to enable the controller to implement the same function in forms of the logic gate, the switch, the application-specific integrated circuit, the programmable logic controller, the built-in microcontroller, and the like. Therefore, the controller can be considered as a hardware component, and an apparatus that is configured to implement various functions and that is included in the controller can also be considered as a structure in the hardware component. Alternatively, an apparatus configured to implement various functions can even be considered as both a software module implementing the method and a structure in the hardware component.

The system, apparatus, module, or unit illustrated in the above-mentioned embodiments can be specifically implemented by using a computer chip or an entity, or can be implemented by using a product having a specific function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, when the embodiments of this specification are implemented, functions of the units can be implemented in one or more pieces of software and/or hardware.

A person skilled in the art should understand that one or more embodiments of this specification can be provided as methods, systems, or computer program products. Therefore, the one or more embodiments of this specification can use a form of hardware only embodiments, software only embodiments, or embodiments with a combination of software and hardware. In addition, this specification can use a form of a computer program product that is implemented on one or more computer-usable storage media (including but not limited to a disk storage, a CD-ROM, an optical storage, or the like) that include computer-usable program code.

This specification is described with reference to the flowcharts and/or block diagrams of the method, the device (system), and the computer program product according to the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more procedures in the flowcharts and/or in one or more blocks in the block diagrams.

Alternatively, these computer program instructions can be stored in a computer-readable storage that can instruct a computer or another programmable data processing device to work in a specific manner, so the instructions stored in the computer-readable storage generate an artifact that includes an instruction apparatus. The instruction apparatus implements a specific function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), one or more input/output interfaces, one or more network interfaces, and one or more storages.

The storage can include a non-persistent memory, a random access memory (RAM), a nonvolatile memory, and/or another form in a computer-readable medium, for example, a read-only memory (ROM) or a flash memory (flash RAM). The storage is an example of the computer-readable medium.

The computer-readable medium includes persistent, non-persistent, removable and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD), or another optical storage, a cassette, a cassette magnetic disk storage, or another magnetic storage device or any other non-transmission medium. The computer storage medium can be configured to store information that can be accessed by a computing device. As described in this specification, the computer-readable medium does not include computer-readable transitory media such as a modulated data signal and a carrier.

It is worthwhile to further note that the terms “include”, “comprise”, or any other variant thereof are intended to cover a non-exclusive inclusion, so that a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the existence of additional identical elements in the process, method, product, or device that includes the element.

One or more embodiments of this specification can be described in the general context of computer-executable instructions, for example, a program module. Generally, the program module includes a routine, a program, an object, a component, a data structure, and the like for executing a specific task or implementing a specific abstract data type. Alternatively, one or more embodiments of this specification can be practiced in distributed computing environments. In the distributed computing environments, tasks are performed by remote processing devices connected through a communication network. In the distributed computing environments, the program module can be located in a local and remote computer storage medium including a storage device.

The embodiments of this specification are described in a progressive manner. For the same or similar parts of the embodiments, references can be made to the embodiments. Each embodiment focuses on a difference from other embodiments. Particularly, the system embodiments are basically similar to the method embodiments, and therefore are described briefly. For related parts, references can be made to some descriptions in the method embodiments.

The above-mentioned descriptions are merely embodiments of this specification, and are not intended to limit this specification. A person skilled in the art can make various changes and variations to this specification. Any modification, equivalent replacement, or improvement made without departing from the spirit and principle of this specification shall fall within the scope of the claims of this specification.

1. A bill processing method, comprising:
determining a request category of a bill access request submitted by a user;
collecting a business payment bill of the user based on the request category, to obtain a bill list;
querying, in a ticket set of the user, a ticket associated with each business payment bill in the bill list; and
configuring a ticket status of each business payment bill in the bill list based on a query result.

2. The method according to claim 1, wherein the collecting a business payment bill of the user based on the request category, to obtain a bill list comprises:
upon determining that the request category is a first request category corresponding to a bill label or a bill group, selecting and collecting a business payment bill corresponding to a specified bill label or a specified bill group from a personal account of the user, to obtain the bill list.

3. The method according to claim 1, wherein the collecting a business payment bill of the user based on the request category, to obtain a bill list comprises:
upon determining that the request category is a second request category corresponding to an application form, determining at least one target bill type and a bill quantity of each target bill type based on a pre-filled target application form;
for any target bill type, performing, based on the target bill type, selection from a personal account of the user and/or an enterprise account used by the user, to obtain a to-be-processed bill;
ranking the to-be-processed bill according to a preset rule, and selecting a corresponding to-be-processed bill as the business payment bill based on the bill quantity; and
collecting the business payment bill to obtain the bill list.

4. The method according to claim 3, wherein the determining at least one target bill type and a bill quantity of each target bill type based on a pre-filled target application form comprises:
determining, based on the pre-filled target application form, at least one application quantity filled in the target application form and an area identifier of a to-be-filled area in which each application quantity is located;
determining a corresponding target bill type based on each area identifier; and
using an application quantity filled in each to-be-filled area as a bill quantity of a target bill type corresponding to an area identifier of the to-be-filled area.

5. The method according to claim 1, wherein the collecting a business payment bill of the user based on the request category, to obtain a bill list comprises:
upon determining that the request category is a third request category corresponding to a custom condition, selecting and collecting a business payment bill from a personal account of the user based on a specified selection condition, to obtain the bill list, wherein the selection condition comprises at least one of the following: a time period to which a bill belongs, a bill label, a bill group, or a bill reimbursement status.

6. The method according to claim 1, further comprising:
obtaining a ticket uploaded by the user and a user identifier of the user;
adding the ticket to the ticket set of the user based on the ticket and the user identifier; and
associating the ticket with at least one bill based on a bill-ticket association operation performed by the user on the at least one selected bill and the ticket.

7. The method according to claim 1, further comprising:
obtaining a ticket sent by a merchant, at least one bill identifier bound to the ticket, and a user identifier of the user;
adding the ticket to the ticket set of the user based on the user identifier; and
associating the ticket with at least one bill corresponding to the bill identifier.

8. The method according to claim 6 or 7, further comprising:
for any ticket, determining, based on a bill identifier of any associated bill associated with the ticket, whether the associated bill belongs to the bill list; and
upon determining that the associated bill belongs to the bill list, updating a ticket status of the associated bill.

9. The method according to claim 1, wherein the configuring a ticket status of each business payment bill in the bill list based on a query result comprises:
determining, based on the query result of the ticket associated with each business payment bill, a ticket status corresponding to the query result;
determining the ticket status of each business payment bill as a configuration parameter of a display page of the business payment bill; and
rendering and generating the display page of the business payment bill based on the configuration parameter.

10. The method according to claim 1, wherein the bill processing method is applied to a payment application, and the determining a request category of a bill access request submitted by a user comprises:
obtaining a bill access request submitted by the user in the payment application, wherein the bill access request carries a request category identifier of a request category selected by the user; and
determining the request category of the bill access request from a plurality of preset request categories based on the request category identifier.

11. (canceled)

12. An electronic device, comprising:
a processor; and
a memory, wherein the memory stores executable instructions that, in response to execution by the processor, cause the processor to:
determine a request category of a bill access request submitted by a user;
collect a business payment bill of the user based on the request category, to obtain a bill list;
query, in a ticket set of the user, a ticket associated with each business payment bill in the bill list; and
configure a ticket status of each business payment bill in the bill list based on a query result.

13. A non-transitory storage medium, comprising instructions stored therein that, when executed by a processor of a computing device, cause the processor to:
determine a request category of a bill access request submitted by a user;
collect a business payment bill of the user based on the request category, to obtain a bill list;
query, in a ticket set of the user, a ticket associated with each business payment bill in the bill list; and
configure a ticket status of each business payment bill in the bill list based on a query result.
